(19) United States
(12) Patent Application Publication
(10) Pub. No.: US 2017/0339100 A1
(43) Pub. Date: Nov. 23, 2017

(54) DEVICE ADDRESS UPDATE BASED ON EVENT OCCURRENCES

(71) Applicant: Empire Technology Development LLC, Wilmington, DE (US)

(72) Inventor: Hyoung-Gon Lee, Gapyeong-gun (KR)

(73) Assignee: Empire Technology Development LLC, Wilmington, DE (US)

(21) Appl. No.: 15/157,557

(22) Filed: May 18, 2016

(51) Int. Cl. H04L 29/12; H04W 4/00

(52) U.S. Cl. CPC H04L 61/2007; H04W 4/008

(57) ABSTRACT

Technologies are generally described for updating a device address based on predetermined event occurrences. In some examples, a method performed under control of a first device that is connected to a second device via a communication network may include generating a device address for the first device for use in data communications with the second device via the communication network; re-setting an event counter; detecting a first occurrence of an event associated with the first device; counting, by the event counter, occurrences of the detected event; determining that the counted number of occurrences reaches a threshold value; and generating a new device address for the first device.

### BACKGROUND

Various peripheral electronic devices such as wearable devices (e.g., smart wristbands, smart watches, etc.), plantar sensors, user interface (U/I) peripheral devices (e.g., head-mounted displays), and/or medical devices, etc., may be communicatively connected to central electronic devices such as smartphones, tablet computers, personal computers, game consoles, etc. Such peripheral devices may transmit/receive data to/from one or more associated central devices via a short-range communication protocols, e.g., Bluetooth, etc.

### SUMMARY

In an example, a method performed under control of a first device that is connected to a second device via a communication network may include: generating a device address for the first device for use in data communications with the second device via the communication network; re-setting an event counter; detecting a first occurrence of an event associated with the first device; counting, by the event counter, occurrences of the detected event; determining that the counted number of occurrences reaches a threshold value; and generating a new device address for the first device.

In another example, a user device may include: a connecting unit configured to connect the user device to another device via a communication network; a detecting unit configured to detect an event associated with the user device; a packet generating unit configured to generate one or more data packets; a transmitting unit configured to transmit at least one of the generated data packets to the other device using a device address; a determining unit configured to determine that a number of the transmitted data packet reaches a threshold value; and an address generating unit configured to generate a new device address for the user device.

In yet another example, a non-transitory computer-readable storage medium may store thereon computer-executable instructions that, in response to execution, cause a first device that is connected to a second device via a communication network, to perform operations including: generating a device address for the first device for use in data communications with the second device via the communication network; re-setting a packet counter; generating one or more data packets; transmitting at least one of the generated data packets to the second device using the device address; counting, by the packet counter, a number of the transmitted data packets; determining that the number of the transmitted data packets reaches a threshold value; and generating a new device address for the first device.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 shows an illustrative example of a first device communicating with a second device with example dynamic device addresses, arranged in accordance with at least some embodiments described herein;

FIG. 2 shows a block diagram illustrating an example architecture of a device to implement a device address updating scheme, arranged in accordance with at least some embodiments described herein;

FIG. 3 shows a block diagram illustrating another example architecture of a device to implement a device address updating scheme, arranged in accordance with at least some embodiments described herein;

FIG. 4 shows a block diagram illustrating yet another example architecture of a device to implement a device address updating scheme, arranged in accordance with at least some embodiments described herein;

FIG. 5 shows a flow diagram of a process for a device to implement an example of a device address updating scheme, arranged in accordance with at least some embodiments described herein;

FIG. 6 shows another flow diagram of a process for a device to implement an example of a device address updating scheme, arranged in accordance with at least some embodiments described herein;

FIG. 7 illustrates computer program products that may be utilized to provide a device address updating scheme, arranged in accordance with at least some embodiments described herein;

FIG. 8 illustrates another computer program products that may be utilized to provide a device address updating scheme, arranged in accordance with at least some embodiments described herein; and

FIG. 9 is a block diagram illustrating an example computing device that may be utilized to provide a device address updating scheme, arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods, apparatuses, systems, devices, and computer program products related to updating a device address based on event occurrences.

In some examples, a first device (a peripheral device) may communicate with a second device (a central device) via a personal area network (PAN) or a near-field communication protocol, e.g., Bluetooth or a wireless communication network, e.g., Wi-Fi or ZigBee. For example, the first device may include, but is not limited to, a wearable device including a smartphone, a smart wristband, and/or a smart watch having an accelerometer, a pedometer or plantar sensor to be used in, for example, shoes, a user interface (U/I) peripheral device having an accelerometer and/or sensor (e.g., a head-mounted display), or a medical device having a sensor (e.g., an implantable cardioverter defibrillator), etc., and the second device may include, but is not limited to, a smartphone, a tablet computer, a personal computer, or a game console, etc. In some examples, the first device may be configured to transmit data packets to the second device, and the second device may be configured to receive the data packets from the first device and analyze the received data packets. By way of example, but not limitation, the first device may also include heart rate monitors (e.g., pulse and blood pressure detectors), pedometers, accelerometers, etc., to thereby be configured to monitor a user's activities (e.g., walking, jogging, running, arm swings, arm movements, etc.) and/or bodily conditions (e.g., heart rate, electrical signaling in the user's heart, etc.) using the accelerometer and/or sensor, and to report the monitored activities and/or bodily conditions to the second device. For instance, the monitored activities may result in data packets, recorded over a predetermined amount of time (e.g., 30 seconds or one minute), including, as examples only: the user's heart rate; the user's blood pressure; a number of steps taken (e.g., walking, jogging, running); a number of arm swings accompanying the steps (e.g., measured past a predetermined angle by an accelerometer); etc. Thus, the first device may generate one or more data packets including such monitored and recorded data, and transmit the generated data packets to the second device. Then, the second device may inform the user of (e.g., display) his/her activities and/or bodily conditions.

As stated above, the first device may communicate with the second device using a near-field communication protocol, e.g., Bluetooth, after connection between the two devices has been established. Subsequently, the data packets described above may be transmitted from the first device to the second device.

Alternatively, when the first device communicates with the second device using a wireless technology, the two devices may use their respective device addresses, such as a MAC (media access control) address for locating each other. In some examples, the first device may generate its device address for use in data communications with the second device via the wireless communication network, and transmit the device address to the second device. Alternatively, the second device may generate a device address for the first device, and transmit the device address to the first device. For example, the generated device address for the first device may be a random private address for communication between the first device and the second device.

Regardless of the first device or the second device generated the device address for the first device, in some examples, the first device may then detect a first occurrence of an event associated with the first device, and count subsequent occurrences of the detected event. The first device may then determine whether the counted number of occurrences reaches a threshold value (within a predetermined amount of time or not), which may be determined and/or adjusted by a manufacturer and/or the user of the first device. For example, the first device may determine or detect: when the user's heartrate has reached an actual or estimated threshold value of beats per minute, i.e., bpm, over a predetermined amount of time, e.g., 30 seconds or one minute; when the user's blood pressure has reached an actual threshold value; when the user has taken an actual or estimated threshold number of steps over a predetermined amount of time, e.g., 30 seconds or one minute; or when the user has swung her arms (beyond a predetermined angular value) in actuality or as an estimated value over a predetermined amount of time, e.g., 30 seconds or one minute; or if the plantar sensor detects an above-threshold-value increase in weight-impact as the user takes a predetermined number of steps, etc.

When the threshold value of occurrences of the detected event has been reached, the first device may re-initiate registration with the second device (e.g., for Bluetooth) or generate a new device address for itself (e.g., for a wireless communication network protocol). The new device address may be a random private address. Then, the first device may renew communication with the second device using the new device address.

In some examples, the event of which occurrences are detected and counted by the first device may include or be related to a movement of the first device, and therefore the device address may be updated when subsequent movements of the first device are detected. By way of example, but not limitation, when the first device is a pedometer or plantar sensor, the detected event associated with the first device may be a step detected as taken by the user. In such cases, the first device may count the number of the user's detected steps, and when the user's detected step count reaches a threshold value (within a predetermined amount of time or not), the first device may generate a new device address. For example, the threshold value may be based on a walking speed, stride, etc. of the user (if the walking speed of the user is 5 kilometers per hour and the average stride of the user is 75 centimeters, the threshold value may be determined as 1000-2000 steps depending on the desired implementation).

As another example, but not as a limitation, when the first device is a smartphone, a smart watch, and/or a smart wristband, any of which may have an accelerometer, the detected event associated with the first device may be an arm swing of the user and/or a vertical movement of one of the user's arms, etc. detected by the accelerometer. In such cases, the first device may count the number of detected arm swings and/or vertical movements, and when a threshold value has been reached (within a predetermined amount of time or not), the first device may generate a new device address for itself.

As yet another example, but not as a limitation, when the first device is a U/I peripheral device which may have an accelerometer and/or sensor (e.g., a head-mounted display), the detected event associated with the first device may be a 6-axis movement beyond a threshold angular displacement (i.e., forward/backward, up/down, left/right translation in three perpendicular axes, combined with changes in orientation through rotation about three perpendicular axes), a button click, and/or a touch, etc. detected by the sensor. In such cases, the first device may count the number of detected events, and when a threshold value has been reached (within a predetermined amount of time or not), the first device may generate a new device address for itself. The counted number of detected events may or may not be measured within a predetermined amount of time, e.g., 30 seconds or one minute, depending upon an implementation.

As still another example, but not as a limitation, when the first device is a medical device that may have a sensor (e.g., an implantable cardioverter defibrillator), the detected event associated with the first device may be a bodily condition to be monitored (e.g., heart rate, electrical signaling in heart, etc.) detected by the sensor. In such cases, the first device may count the amount of the detected bodily condition (e.g., the number of heartbeats, the amount of energy stemmed from electrical signals in heart, etc.), and when a threshold value has been reached (within a predetermined amount of time or not), the first device may initiate a new connection or registration with the second device or the first device may generate a new device address for itself, depending upon the communication protocol being utilized between the two devices.

Additionally and/or alternatively, the first device may generate one or more data packets, and transmit at least one of the generated data packets to the second device using the device address. At least some of the generated data packets may be associated with the occurrences of the detected event. For example, the monitored activities may result in data packets, recorded over a predetermined amount of time (e.g., 30 seconds or one minute), including, as examples only: the user's heart rate; the user's blood pressure; a number of steps taken (e.g., walking, jogging, running); a number of arm swings accompanying the steps (e.g., measured past a predetermined angle by an accelerometer); etc.

Further, the first device may count a number of the transmitted data packets using, for example, a packet counter, and determine whether the number of the transmitted data packets reaches a threshold value (within a predetermined amount of time or not, depending upon the implementation). In accordance with some embodiments, when the number of the data packets transmitted from the first device to the second device reaches the threshold value, the first device may initiate a new connection or registration with the second device or the first device may generate the new device address for itself, depending upon the communication protocol being utilized. Thus, the device address may be updated when more movements of the first device are performed and/or detected, and thus more packets may be transmitted by the first device. By way of example, but not limitation, when the first device is a pedometer or plantar sensor, the first device may generate data packets associated with the user's steps, and transmit the data packets to the second device. Further, when the number of the transmitted data packets reaches a threshold value, the first device may generate a new device address. That is, if a user is not walking, jogging, running, etc. (e.g., just sitting), fewer packets may be sent, and thus fewer device address updates may be required.

In some examples, when the first device generates the new device address, the first device may send the new device address to the second device. Then, the first device and the second device may communicate with each other using the new device address.

As such, the first device may update its device address to protect privacy (by making it difficult to track device address) in power-efficient way.

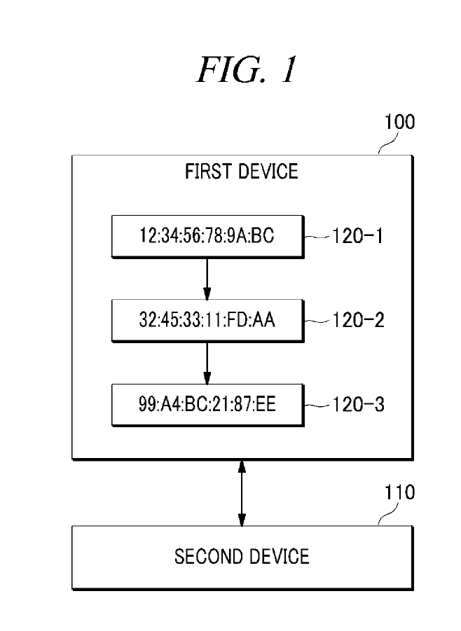

FIG. 1 shows an illustrative example of a first device 100 communicating with a second device 110 with example dynamic device addresses 120-1, 120-2 and 120-3, arranged in accordance with at least some embodiments described herein.

As depicted, first device 100 may be communicatively coupled to second device 110 via a personal area network (PAN) or a near-field communication protocol, e.g., Bluetooth or a wireless communication network, e.g., Wi-Fi or ZigBee, etc. First device 100 and second device 110 may be, respectively, a peripheral device and a central device. By way of example, but not limitation, first device 100 may include a wearable device such as, for example, a smartphone, a smart wristband, and/or a smart watch, any of which may have an accelerometer, a pedometer or plantar sensor to be used in shoes, a user interface (U/I) peripheral device that may have an accelerometer and/or sensor such as, for example, a head-mounted display, or a medical device that may have a sensor such as, for example, an implantable cardioverter defibrillator, etc. By way of example, but not limitation, second device 110 may include a smartphone, a tablet computer, a personal computer, or a game console, etc.

In some embodiments, first device 100 may be configured be registered with or otherwise connected to second device 110, via a near-field communication protocol; alternatively, first device 100 may be configured to generate a first device address 120-1 to be used in data communications with second device 110 via the communication network. By way of example, but not limitation, first device address 120-1 may be a random private address in a form of a MAC (media access control) address. First device 100 may then be configured to announce its presence to second device 110. For instance, first device 100 may send to second device 110 advertising packets including first device address 120-1, so that pairing and/or bonding between first device 100 and second device 110 may be performed. In some alternative embodiments, second device 110 may be configured to generate first device address 120-1.

In some embodiments, first device 100 may be configured to detect a first occurrence of an event associated with first device 100. In some examples, the detected event associated with first device 100 may be a movement of first device 100. By way of example, but not limitation, when first device 100 is a pedometer or plantar sensor, the detected event associated with first device 100 may be a detected step taken by the user. As another example, but not as a limitation, when first device 100 is a smartphone, a smart watch, and/or a smart wristband, any of which may have an accelerometer, the detected event associated with first device 100 may be a detected arm swing of the user and/or a detected vertical movement of one of the user's arms, etc., and thus the accelerometer that may be included in first device 100 may detect the event. As yet another example, but not as a limitation, when first device 100 is a U/I peripheral device which may have an accelerometer and/or sensor (e.g., a head-mounted display), the detected event associated with first device 100 may be a 6-axis movement beyond an angular threshold value, a button click, and/or a touch, etc., and thus the accelerometer and/or sensor that may be included in first device 100 may detect the event. By way of still another example, but not limitation, when first device 100 is a medical device which may have a sensor (e.g., an implantable cardioverter defibrillator), the detected event associated with first device 100 may be a bodily condition to be monitored (e.g., heart rate, electrical signaling in heart, etc.), and thus the sensor that may be included in first device 100 may detect the event.

In some embodiments, first device 100 may be configured to count occurrences of the detected event using an event counter. First device 100 may then be configured to generate a second device address 120-2, when first device 100 determines that the counted number of occurrences reaches a threshold value. For instance, the threshold value may be determined and/or adjusted by a manufacturer and/or a user of first device 100 based at least in part on the battery life of first device 100. Such threshold values may be intended to simulate biometric conditions that may be indicative of conditions that require additional security measures. For example, an increased heartrate of 120 bpm may be indicative of stress or anxiety, or a running step rate of 200 steps per minute may be indicative of a flight mode. In such examples, which are not to be interpreted as limiting, the user's biometrics or other bodily conditions may indicate that the user and/or the user's data may be at risk. Thus, the data communication operations described herein may be utilized for protective purposes.

In some embodiments, first device 100 may be configured to repeat the above procedure, and generate a third device address 120-3, when first device 100 determines that the counted number of occurrences reaches the threshold value again. This process may be repeated so long as the threshold number of occurrences of the event is detected.

In some additional and/or alternative embodiments, first device 100 may be configured to change device addresses based on the number of data packets transmitted from first device 100 to second device 110. Specifically, first device 100 may be configured to generate one or more data packets including those related to the detected first occurrence of the event associated with first device 100, and transmit the generated data packet to second device 110 via the communication network using first device address 120-1. Further, first device 100 may be configured to count a number of the transmitted data packets. In such cases, first device 100 may be configured to generate second device address 120-2 when the number of the transmitted data packets reaches a threshold value. By way of example, but not limitation, the threshold value may also be determined and/or adjusted by the manufacturer and/or the user of first device 100 based at least in part on the battery life of first device 100.

Although it is illustrated in FIG. 1 that first device 100 updates its device address twice (i.e., from device address 120-1 to device address 120-2 and from device address 120-2 to device address 120-3), first device 100 may change or update its device address any number of times.

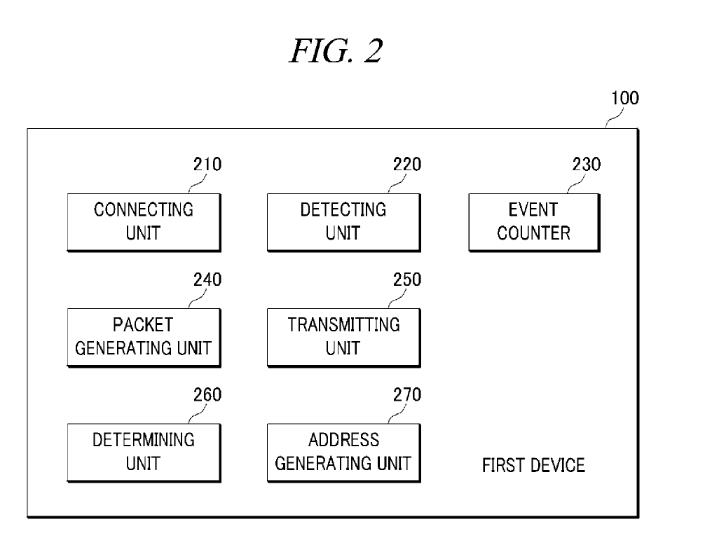

FIG. 2 shows a block diagram illustrating an example architecture of first device 100 to implement a device address updating scheme, arranged in accordance with at least some embodiments described herein. As depicted in FIG. 2, first device 100 may include a connecting unit 210, a detecting unit 220, an event counter 230, a packet generating unit 240, a transmitting unit 250, a determining unit 260, and an address generating unit 270. Although illustrated as discrete components, various components may be divided into additional components, combined into fewer components, or eliminated altogether while being contemplated within the scope of the disclosed subject matter. It will be understood by those skilled in the art that each function and/or operation of the components may be implemented, individually and/or collectively, by a wide range of hardware, software, firmware, or virtually any combination thereof. Further, reference may be made to the embodiments depicted and described with reference to FIG. 1.

In some embodiments, connecting unit 210 may be configured to connect first device 100 to second device 110 via a communication network. By way of example, but not limitation, the communication network is a short-range wireless communication network such as, for example, a network using Bluetooth, Wi-Fi or ZigBee standard. For instance, in case of Bluetooth, connecting unit 210 may be configured to perform Bluetooth pairing using a device address generated by address generating unit 270.

In some embodiments, detecting unit 220 may be configured to detect an event associated with first device 100. In some examples, the detected event associated with first device 100 may be a movement of first device 100. By way of example, but not limitation, when first device 100 is a pedometer or plantar sensor, the detected event associated with first device 100 may be a detected step taken by a user. By way of another example, but not limitation, when first device 100 is a smartphone, a smart watch, and/or a smart wristband, any of which may have an accelerometer, the detected event associated with first device 100 may be a detected arm swing of the user and/or a detected vertical movement of one of the user's arms, etc., and thus the accelerometer that may be included in first device 100 may detect the event. By way of yet another example, but not limitation, when first device 100 is a U/I peripheral device which may have an accelerometer and/or sensor (e.g., a head-mounted display), the detected event associated with first device 100 may be a 6-axis movement, a button click, and/or a touch, etc., and thus the accelerometer and/or sensor that may be included in first device 100 may detect the event. By way of still another example, but not limitation, when first device 100 is a medical device which may have a sensor (e.g., an implantable cardioverter defibrillator), the detected event associated with first device 100 may be a bodily condition to be monitored, and thus the sensor that may be included in first device 100 may detect the event.

In some embodiments, event counter 230 may be configured to count occurrences of the event detected by detecting unit 220. In some examples, event counter 230 may be reset whenever a device address for first device 100 is generated.

In some embodiments, packet generating unit 240 may be configured to generate one or more data packets based at least in part on the event detected by detecting unit 220. In some examples, packet generating unit 240 may be configured to generate data packets associated with a movement of first device 100. By way of example, but not limitation, when first device 100 is a pedometer or plantar sensor, packet generating unit 240 may be configured to generate data packets associated with detected steps taken by the user. By way of another example, but not limitation, when first device 100 is a smartphone, a smart watch, and/or a smart wristband, any of which may have an accelerometer, packet generating unit 240 may be configured to generate data packets associated with a detected arm swing of the user and/or a detected vertical movement of one of the user's arms, etc. By way of yet another example, but not limitation, when first device 100 is a U/I peripheral device which may have an accelerometer and/or sensor (e.g., a head-mounted display), packet generating unit 240 may be configured to generate data packets associated with the user's 6-axis movement, button click, and/or touch, etc. By way of still another example, but not limitation, when first device 100 is a medical device which may have a sensor (e.g., an implantable cardioverter defibrillator), packet generating unit 240 may be configured to generate data packets associated with the user's bodily condition.

In some embodiments, transmitting unit 250 may be configured to transmit at least one of the data packets generated by packet generating unit 240 to second device 110 using the device address generated by address generating unit 270. In some embodiments, transmitting unit 250 may be further configured to transmit the at least one of the generated data packets to second device 110 using a new device address after the new device address is generated by address generating unit 270.

In some embodiments, determining unit 260 may be configured to determine whether the number of occurrences counted by event counter 230 reaches a threshold value. By way of example, but not limitation, the threshold value may be determined and/or adjusted by a manufacturer and/or the user of first device 100 based at least in part on the battery life of first device 100. For example, in cases of the pedometer or plantar sensor, the threshold value may be further based on a walking speed, stride, etc. of the user (if the walking speed of the user is 5 kilometers per hour and the average stride of the user is 75 centimeters, the threshold value may be determined as 1000-2000 steps depending on the desired implementation).

In some embodiments, address generating unit 270 may be configured to generate the new device address for first device 100 in response to the determination by determining unit 260 that the number of occurrences counted by event counter 230 reaches the threshold value. By way of example, but not limitation, the new device address may be a random private address.

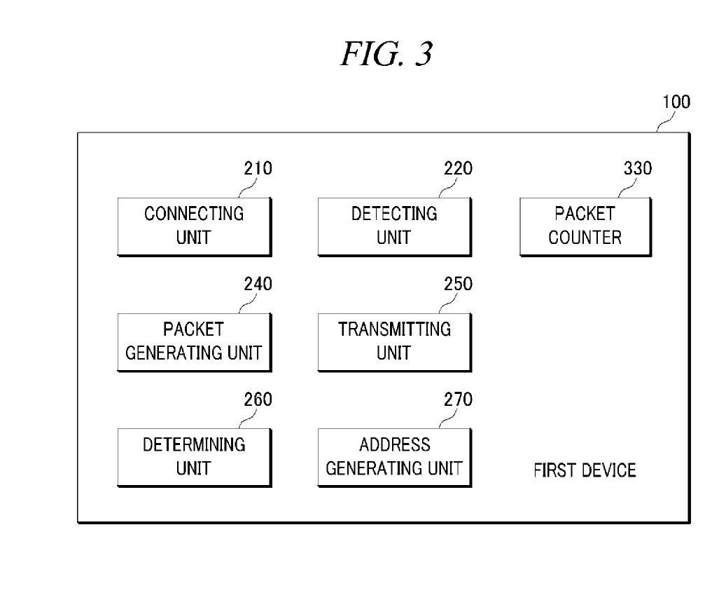

FIG. 3 shows a block diagram illustrating another example architecture of first device 100 to implement a device address updating scheme, arranged in accordance with at least some embodiments described herein. As depicted in FIG. 3, first device 100 may include connecting unit 210, detecting unit 220, a packet counter 330, packet generating unit 240, transmitting unit 250, determining unit 260, and address generating unit 270. Although illustrated as discrete components, various components may be divided into additional components, combined into fewer components, or eliminated altogether while being contemplated within the scope of the disclosed subject matter. It will be understood by those skilled in the art that each function and/or operation of the components may be implemented, individually and/or collectively, by a wide range of hardware, software, firmware, or virtually any combination thereof. Further, reference may be made to the embodiments depicted and described with reference to FIGS. 1 and 2. For example, each function and/or operation of connecting unit 210, detecting unit 220, packet generating unit 240, transmitting unit 250, determining unit 260, and address generating unit 270 in FIG. 3 may be same as or similar to those described with reference to FIG. 2. Those descriptions will be omitted in the following description of FIG. 3.

In some embodiments, packet counter 330 may be configured to count a number of the data packets transmitted by transmitting unit 250.

In some embodiments, determining unit 260 may be further configured to determine whether the number of the data packets counted by packet counter 330 reaches a threshold value. By way of example, but not limitation, the threshold value may also be determined and/or adjusted by a manufacturer and/or a user of first device 100 based at least in part on the battery life of first device 100.

In some embodiments, address generating unit 270 may be further configured to generate a new device address for first device 100 when determining unit 260 determines that the number of the transmitted data packet reaches the threshold value.

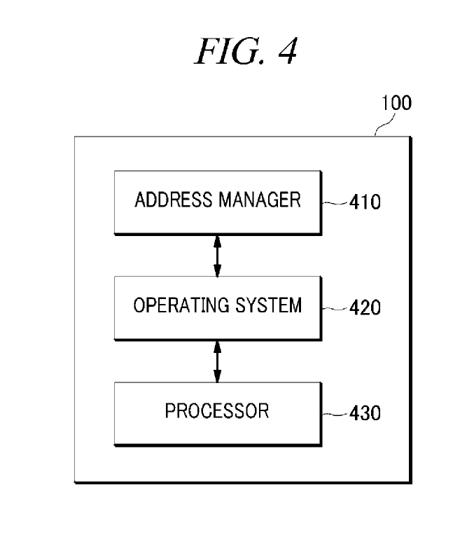

FIG. 4 shows a block diagram illustrating yet another example architecture of first device 100 to implement a device address updating scheme, arranged in accordance with at least some embodiments described herein. Reference may be made to the embodiments depicted and described with reference to FIGS. 1 to 3.

As depicted, first device 100 may include an address manager 410, an operating system 420 and a processor 430. Address manager 410 may be adapted to operate on operating system 420 such that the device address updating scheme, as described herein, may be provided. For instance, address manager 410 may include instructions that may be arranged to perform the functions as described herein on operating system 420. Operating system 420 may allow address manager 410 to manipulate processor 430 to implement the device address updating scheme as described herein.

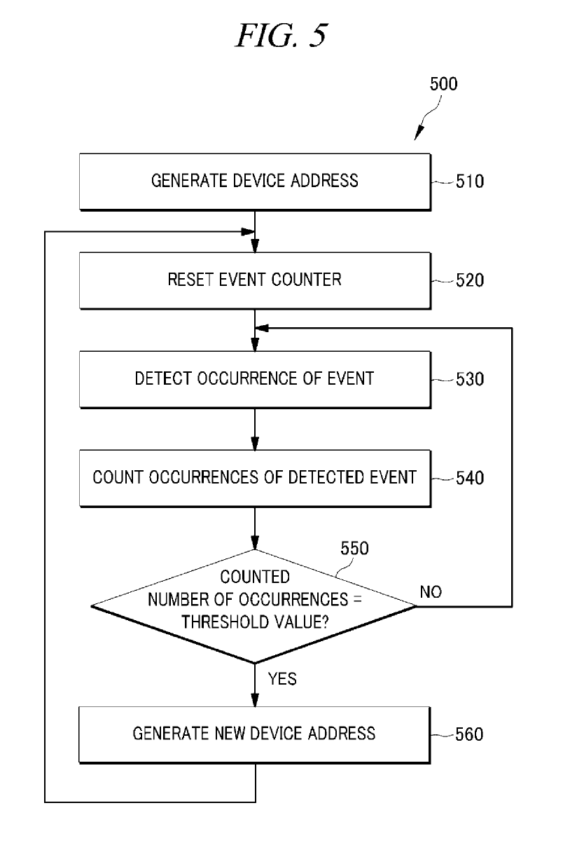

FIG. 5 shows a flow diagram of a process 500 for first device 100 to implement an example of a device address updating scheme, arranged in accordance with at least some embodiments described herein. The operations of process 500 may be implemented in first device 100 including connecting unit 210, detecting unit 220, event counter 230, packet generating unit 240, transmitting unit 250, determining unit 260, and address generating unit 270, as illustrated in FIGS. 1-4. Process 500 may include one or more operations, actions, or functions as illustrated by one or more blocks 510, 520, 530, 540, 550 and/or 560. Although illustrated as discrete blocks, various blocks may be divided into additional blocks, combined into fewer blocks, or eliminated, depending on the desired implementation. Processing may begin at block 510.

At block 510 (Generate Device Address), first device 100 (such as, for example, address generating unit 270) may generate a device address for first device 100 for use in data communications with second device 110 via a communication network such as, for example, a network using Bluetooth, Wi-Fi or ZigBee standard. For example, the generated device address may be a random private address in a form of a MAC (media access control) address. Processing may continue from block 510 to block 520.

At block 520 (Reset Event Counter), first device 100 may reset event counter 230. The reset value may be zero (0). Processing may continue from block 520 to block 530.

At block 530 (Detect Occurrence of Event), first device 100 (such as, for example, detecting unit 220) may detect an occurrence of an event associated with first device 100. In some examples, the detected event associated with first device 100 may be a movement of first device 100. By way of example, but not limitation, when first device 100 is a pedometer or plantar sensor, the detected event associated with first device 100 may be a detected step taken by a user. By way of another example, but not limitation, when first device 100 is a smartphone, a smart watch, and/or a smart wristband, any of which may have an accelerometer, the detected event associated with first device 100 may be a detected arm swing of the user and/or a detected vertical movement of one of the user's arms, etc., and thus the accelerometer that may be included in first device 100 may detect the event. By way of yet another example, but not limitation, when first device 100 is a U/I peripheral device which may have an accelerometer and/or sensor (e.g., a head-mounted display), the detected event associated with first device 100 may be a 6-axis movement, a button click, and/or a touch, etc., and thus the accelerometer and/or sensor that may be included in first device 100 may detect the event. By way of still another example, but not limitation, when first device 100 is a medical device which may have a sensor (e.g., an implantable cardioverter defibrillator), the detected event associated with first device 100 may be a bodily condition to be monitored, and thus the sensor that may be included in first device 100 may detect the event. Processing may continue from block 530 to block 540.

At block 540 (Count Occurrences of Detected Event), first device 100 (such as, for example, event counter 230) may count occurrences of the detected event. Processing may continue from block 540 to block 550.

At block 550 (Counted Number of Occurrences=Threshold Value?), first device 100 (such as, for example, determining unit 260) may determine whether the counted number of occurrences reaches a threshold value. By way of example, but not limitation, the threshold value may be determined and/or adjusted by a manufacturer and/or the user of first device 100 based at least in part on the battery life of first device 100. For example, in cases of the pedometer or plantar sensor, the threshold value may be further based on a walking speed, stride, etc. of the user (if the walking speed of the user is 5 kilometers per hour and the average stride of the user is 75 centimeters, the threshold value may be determined as 1000-2000 steps depending on the desired implementation). When first device 100 determines that the counted number of occurrences reaches the threshold value, processing may continue from block 550 to block 560. Otherwise, processing may continue from block 550 to block 530.

At block 560 (Generate New Device Address), first device 100 (such as, for example, address generating unit 270) may generate a new device address for first device 100. By way of example, but not limitation, the new device address may be a random private address in a form of a MAC (media access control) address. Processing may continue from block 560 to block 520, and repeat from blocks 520 to 560.

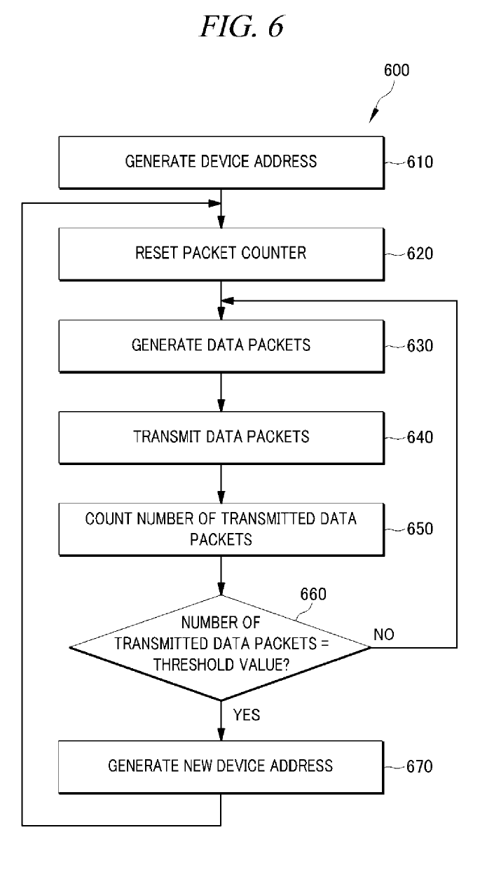

FIG. 6 shows another flow diagram of a process 600 for first device 100 to implement an example of a device address updating scheme, arranged in accordance with at least some embodiments described herein. The operations of process 600 may be implemented in first device 100 including connecting unit 210, detecting unit 220, packet counter 330, packet generating unit 240, transmitting unit 250, determining unit 260, and address generating unit 270, as illustrated in FIGS. 1-5. Process 600 may include one or more operations, actions, or functions as illustrated by one or more blocks 610, 620, 630, 640, 650, 660 and/or 670. Although illustrated as discrete blocks, various blocks may be divided into additional blocks, combined into fewer blocks, or eliminated, depending on the desired implementation. Processing may begin at block 610.

At block 610 (Generate Device Address), first device 100 (such as, for example, address generating unit 270) may generate a device address for first device 100 for use in data communications with second device 110 via a communication network such as, for example, a network using Bluetooth, Wi-Fi or ZigBee standard. For example, the generated device address may be a random private address in a form of a MAC (media access control) address. Processing may continue from block 610 to block 620.

At block 620 (Reset Packet Counter), first device 100 may reset packet counter 330. The reset value may be zero (0). Processing may continue from block 620 to block 630.

At block 630 (Generate Data Packets), first device 100 (such as, for example, packet generating unit 240) may generate one or more data packets. In some examples, at least some of the one or more data packets may be associated with one or more occurrences of an event associated with first device 100. In some examples, the event may be associated with a movement of first device 100. By way of example, but not limitation, when first device 100 is a pedometer or plantar sensor, the detected event associated with first device 100 may be a detected step taken by a user. By way of another example, but not limitation, when first device 100 is a smartphone, a smart watch, and/or a smart wristband, any of which may have an accelerometer, the detected event associated with first device 100 may be a detected arm swing of the user and/or a detected vertical movement of one of the user's arms, etc. By way of yet another example, but not limitation, when first device 100 is a U/I peripheral device which may have an accelerometer and/or sensor (e.g., a head-mounted display), the detected event associated with first device 100 may be a 6-axis movement, a button click, and/or a touch, etc. By way of still another example, but not limitation, when first device 100 is a medical device which may have a sensor (e.g., an implantable cardioverter defibrillator), the detected event associated with first device 100 may be a bodily condition to be monitored. Processing may continue from block 630 to block 640.

At block 640 (Transmit Data Packets), first device 100 (such as, for example, transmitting unit 250) may transmit at least one of the generated data packets to second device 110 using the device address. Processing may continue from block 640 to block 650.

At block 650 (Count Number of Transmitted Data Packets), first device 100 (such as, for example, packet counter 330) may count a number of the transmitted data packets. Processing may continue from block 650 to block 660.

At block 660 (Number of Transmitted Data Packets=Threshold Value?), first device 100 (such as, for example, determining unit 260) may determine whether the number of the transmitted data packets reaches a threshold value. When first device 100 determines that the number of the transmitted data packets reaches the threshold value, processing may continue from block 660 to block 670. Otherwise, processing may continue from block 660 to block 630.

At block 670 (Generate New Device Address), first device 100 (such as, for example, address generating unit 270) may generate a new device address for first device 100. By way of example, but not limitation, the new device address may be a random private address in a form of a MAC (media access control) address. Processing may continue from block 670 to block 620, and repeat from blocks 620 to 670.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

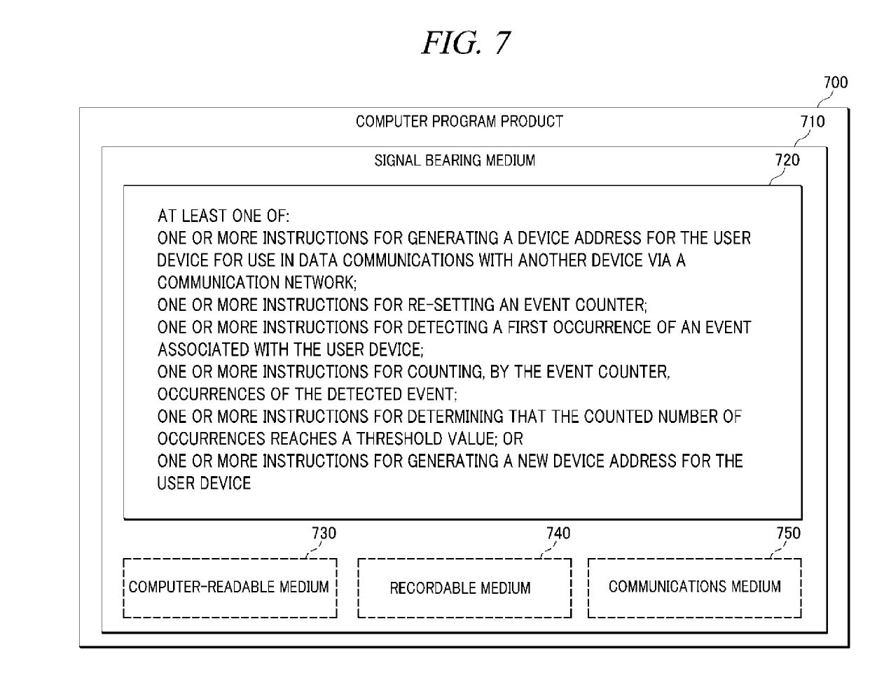

FIG. 7 illustrates computer program products 700 that may be utilized to provide a device address updating scheme, arranged in accordance with at least some embodiments described herein. Program product 700 may include a signal bearing medium 710. Signal bearing medium 710 may include one or more instructions 720 that, when executed by, for example, a user device such as first device 100, may provide the functionality described above with respect to FIGS. 1-6. By way of example, instructions 720 may include: one or more instructions for generating a device address for the user device for use in data communications with another device via a communication network; one or more instructions for re-setting an event counter; one or more instructions for detecting a first occurrence of an event associated with the user device; one or more instructions for counting, by the event counter, occurrences of the detected event; one or more instructions for determining that the counted number of occurrences reaches a threshold value; or one or more instructions for generating a new device address for the user device. Thus, for example, referring to FIG. 2, first device 100 may undertake one or more of the blocks shown in FIG. 5 in response to instructions 720.

In some implementations, signal bearing medium 710 may encompass a computer-readable medium 730, such as, but not limited to, a hard disk drive, a CD, a DVD, a digital tape, memory, etc. In some implementations, signal bearing medium 710 may encompass a recordable medium 740, such as, but not limited to, memory, read/write (R/W) CDs, R/W DVDs, etc. In some implementations, signal bearing medium 710 may encompass a communications medium 750, such as, but not limited to, a digital and/or an analog communication medium (e.g., a fiber optic cable, a waveguide, a wired communications link, a wireless communication link, etc.). Thus, for example, program product 700 may be conveyed to one or more modules of first device 100 by an RF signal bearing medium 720, where the signal bearing medium 720 is conveyed by a wireless communications medium 750 (e.g., a wireless communications medium conforming with the IEEE 802.11 standard).

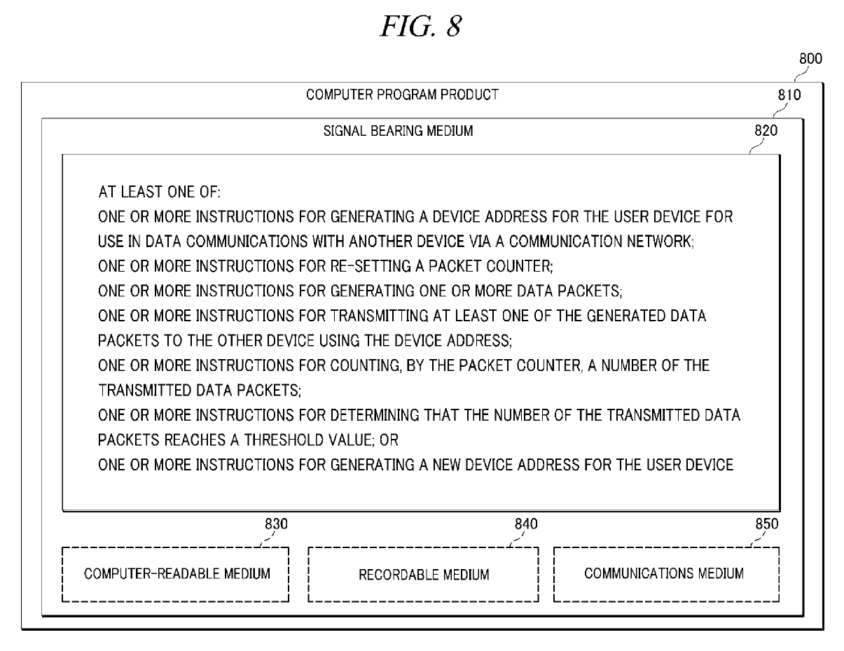

FIG. 8 illustrates another computer program products 800 that may be utilized to provide a device address updating scheme, arranged in accordance with at least some embodiments described herein. Program product 800 may include a signal bearing medium 810. Signal bearing medium 810 may include one or more instructions 820 that, when executed by, for example, a user device such as first device 100, may provide the functionality described above with respect to FIGS. 1-7. By way of example, instructions 820 may include: one or more instructions for generating a device address for the user device for use in data communications with another device via a communication network; one or more instructions for re-setting a packet counter; one or more instructions for generating one or more data packets; one or more instructions for transmitting at least one of the generated data packets to the other device using the device address; one or more instructions for counting, by the packet counter, a number of the transmitted data packet; one or more instructions for determining that the number of the transmitted data packet reaches a threshold value; or one or more instructions for generating a new device address for the user device. Thus, for example, referring to FIG. 3, first device 100 may undertake one or more of the blocks shown in FIG. 6 in response to instructions 820.

In some implementations, signal bearing medium 810 may encompass a computer-readable medium 830, such as, but not limited to, a hard disk drive, a CD, a DVD, a digital tape, memory, etc. In some implementations, signal bearing medium 810 may encompass a recordable medium 840, such as, but not limited to, memory, read/write (R/W) CDs, R/W DVDs, etc. In some implementations, signal bearing medium 810 may encompass a communications medium 850, such as, but not limited to, a digital and/or an analog communication medium (e.g., a fiber optic cable, a waveguide, a wired communications link, a wireless communication link, etc.). Thus, for example, program product 800 may be conveyed to one or more modules of first device 100 by an RF signal bearing medium 820, where the signal bearing medium 820 is conveyed by a wireless communications medium 850 (e.g., a wireless communications medium conforming with the IEEE 802.11 standard).

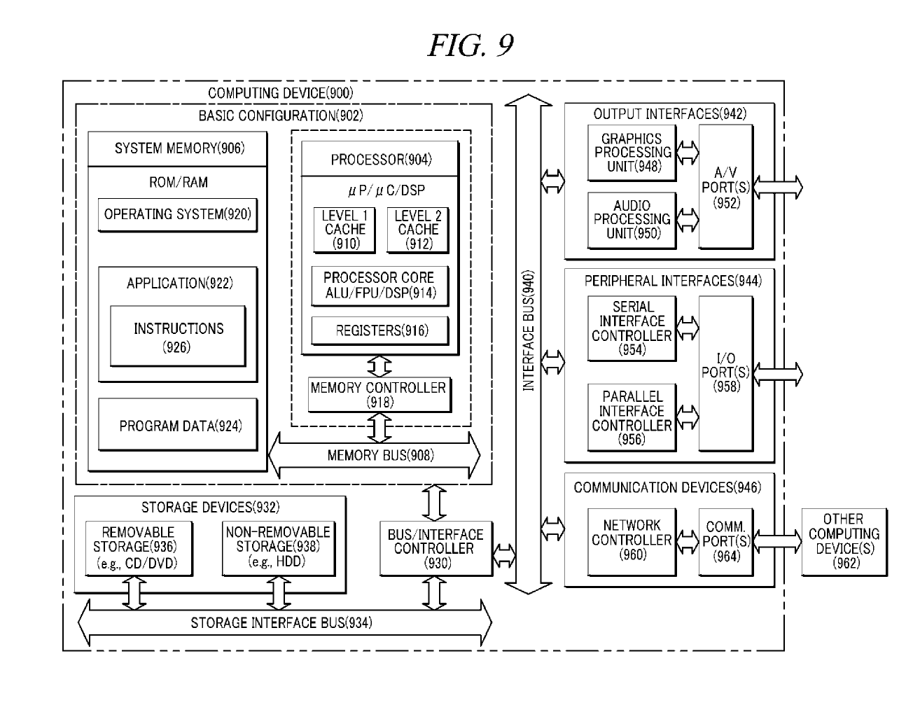

FIG. 9 is a block diagram illustrating an example computing device 900 that may be utilized to provide a device address updating scheme, arranged in accordance with at least some embodiments described herein. In these examples, elements of computing device 900 may be arranged or configured for a user device. In a very basic configuration 902, computing device 900 typically includes one or more processors 904 and a system memory 906. A memory bus 908 may be used for communicating between processor 904 and system memory 906.

Depending on the desired configuration, processor 904 may be of any type including but not limited to a microprocessor (μP), a microcontroller (μC), a digital signal processor (DSP), or any combination thereof. Processor 904 may include one or more levels of caching, such as a level one cache 910 and a level two cache 912, a processor core 914, and registers 916. An example processor core 914 may include an arithmetic logic unit (ALU), a floating point unit (FPU), a digital signal processing core (DSP Core), or any combination thereof. An example memory controller 918 may also be used with processor 904, or in some implementations memory controller 918 may be an internal part of processor 904.

Depending on the desired configuration, system memory 906 may be of any type including but not limited to volatile memory (such as RAM), non-volatile memory (such as ROM, flash memory, etc.) or any combination thereof. System memory 906 may include an operating system 920, one or more applications 922, and program data 924. Application 922 may include instructions 926 that may be arranged to perform the functions as described herein including the actions described with respect to first device 100 architectures as shown in FIGS. 1-4 or including the actions described with respect to the flow charts shown in FIGS. 5-6. In some examples, application 922 may be arranged to operate with program data 924 on an operating system 920 such that the device address updating scheme as described herein may be provided.

Computing device 900 may have additional features or functionality, and additional interfaces to facilitate communications between basic configuration 902 and any required devices and interfaces. For example, a bus/interface controller 930 may be used to facilitate communications between basic configuration 902 and one or more data storage devices 932 via a storage interface bus 934. Data storage devices 932 may be removable storage devices 936, non-removable storage devices 938, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 906, removable storage devices 936 and non-removable storage devices 938 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 900. Any such computer storage media may be part of computing device 900.

Computing device 900 may also include an interface bus 940 for facilitating communication from various interface devices (e.g., output interfaces 942, peripheral interfaces 944, and communication devices 946) to basic configuration 902 via bus/interface controller 930. Example output interfaces 942 include a graphics processing unit 948 and an audio processing unit 950, which may be configured to communicate to various external devices such as a display or speakers via one or more A/V ports 952. Example peripheral interfaces 944 include a serial interface controller 954 or a parallel interface controller 956, which may be configured to communicate with external devices such as input devices (e.g., keyboard, mouse, pen, voice input device, touch input device, etc.) or other peripheral devices (e.g., printer, scanner, etc.) via one or more I/O ports 958. An example communication device 946 includes a network controller 960, which may be arranged to facilitate communications with one or more other computing devices 962 over a network communication link via one or more communication ports 964.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 900 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 900 may also be implemented as a personal computer including both laptop computer and non-laptop computer configurations.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A method performed under control of a first device that is connected to a second device via a communication network, the method comprising:
generating a device address for the first device for use in data communications with the second device via the communication network;
re-setting an event counter;
detecting a first occurrence of an event associated with the first device;
counting, by the event counter, occurrences of the detected event;
determining that the counted number of occurrences reaches a threshold value; and
generating a new device address for the first device.

2. The method of claim 1, further comprising:
generating at least one data packet based at least in part on the detected first occurrence of the event associated with the first device.

3. The method of claim 2, further comprising:
transmitting the generated data packet to the second device via the communication network using the generated device address.

4. The method of claim 1, wherein the communication network is a short-range wireless communication network.

5. The method of claim 1, wherein the communication network is a network using Bluetooth standard.

6. The method of claim 1, wherein the generated device address is a random private address.

7. The method of claim 1, wherein the event associated with the first device is a movement of the first device.

8. The method of claim 1, wherein the event associated with the first device is a step.

9. The method of claim 1, wherein the first device includes at least one of a wearable device, a U/I peripheral device or a medical device.

10. A user device, comprising:
a connecting unit configured to connect the user device to another device via a communication network;
a detecting unit configured to detect an event associated with the user device;
a packet generating unit configured to generate one or more data packets;
a transmitting unit configured to transmit at least one of the generated data packets to the other device using a device address;
a determining unit configured to determine that a number of the transmitted data packet reaches a threshold value; and
an address generating unit configured to generate a new device address for the user device.

11. The user device of claim 10, wherein at least some of the data packets generated by the packet generating unit are associated with the event detected by the detecting unit.

12. The user device of claim 10, wherein the device address is generated by the other device.

13. The user device of claim 10, wherein the communication network is a short-range wireless communication network.

14. The user device of claim 10, wherein the communication network is a network using Bluetooth standard.

15. The user device of claim 10, wherein the transmitting unit is further configured to transmit the at least one of the generated data packets to the other device using the new device address after the new device address is generated.

16. The user device of claim 10, wherein the device address includes a random private address.

17. The user device of claim 10, wherein the event associated with the user device is a movement of the user device.

18. The user device of claim 10, wherein the user device includes at least one of a wearable device, a U/I peripheral device or a medical device.

19. A non-transitory computer-readable storage medium having stored thereon computer-executable instructions that, in response to execution, cause a first device that is connected to a second device via a communication network, to perform operations, comprising:
generating a device address for the first device for use in data communications with the second device via the communication network;
re-setting a packet counter;
generating one or more data packets;
transmitting at least one of the generated data packets to the second device using the device address;
counting, by the packet counter, a number of the transmitted data packets;
determining that the number of the transmitted data packets reaches a threshold value; and
generating a new device address for the first device.

20. The non-transitory computer-readable storage medium of claim 19, wherein the operations further comprise:
detecting one or more occurrences of an event associated with the first device.

21. The non-transitory computer-readable storage medium of claim 20, wherein at least some of the one or more data packets are associated with the one or more occurrences of the event.

22. The non-transitory computer-readable storage medium of claim 19, wherein the operations further comprise:
transmitting the at least one of the generated data packet to the second device via the communication network using the new device address after the new device address is generated.

23. The non-transitory computer-readable storage medium of claim 19, wherein the event associated with the first device is a movement of the first device.

24. The non-transitory computer-readable storage medium of claim 19, wherein the first device includes at least one of a wearable device, a U/I peripheral device or a medical device.
